(19) United States
(12) Patent Application Publication
(10) Pub. No.: US 2018/0076627 A1
(43) Pub. Date: Mar. 15, 2018

(54) RENEWABLE ENERGY SYSTEM EMPLOYING A TRANSFORMER HAVING A REDUCED RATING

(71) Applicant: EATON CORPORATION, CLEVELAND, OH (US)

(72) Inventor: CHRISTOPHER SCOTT THOMPSON, PROVO, UT (US)

(73) Assignee: EATON CORPORATION, CLEVELAND, OH (US)

(21) Appl. No.: 15/261,227

(22) Filed: Sep. 9, 2016

(51) Int. Cl. H02J 3/38; H02M 7/44

(52) U.S. Cl. CPC H02J 3/383; H02J 3/386; H02M 7/44

(57) ABSTRACT

A renewable energy system includes a transformer, a first inverter coupled to a renewable energy source and the primary side of the transformer, and a second inverter coupled to an energy storage device and the primary side of the transformer. The system further includes a controller coupled to the first inverter and the second inverter, wherein the controller is structured and configured to control operation of the first inverter and the second inverter in a manner such that a total power provided to the primary side of the transformer does not exceed the power rating of the transformer, and wherein the power rating of the transformer is less than a sum of the maximum output power ratings of all inverters that are coupled to the transformer.

### BACKGROUND

### Field

The disclosed concept pertains generally to renewable energy systems, such as photovoltaic (PV) systems and wind generation systems, and, more particularly, to a renewable energy system that includes an energy storage device such as a battery and one or more renewable energy sources, and that employs a transformer having a reduced rating in order to minimize unused transformer capacity.

### Background Information

Traditionally, the major resources for generating electricity have been in the form of fossil fuels, such as oil, coal, and natural gas. More recently, however, there has been an increased focus on shifting electricity generation to renewable resources in order to reduce dependence on fossil fuels and decrease emissions of climate-changing greenhouse gases and other pollutants. In particular, many places have looked to increase their utilization of utility connected renewable energy sources, such as solar photovoltaic (PV) systems and wind generation systems (commonly referred to as solar farms and wind farms), for electricity generation to supplement traditional fossil fuel-based generation.

In grid-tied renewable energy systems, it is becoming more common to have battery storage coupled with the renewable energy generation. In such cases, the storage batteries can capture power generated from one or more renewable energy sources so that it can be injected into the grid at a later time. In some other cases the batteries may also absorb excess power that cannot be injected into the local grid because the solar generation is exceeding what is allowed by the local connection or interconnection agreement rules. The stored energy can then be dispatched a later time when optimal value can be earned for the electricity. In addition, energy stored in batteries can be used to smooth the renewable energy generation as needed, such as when cloudy conditions limit solar energy production.

Some implementations that couple battery storage with renewable energy generation employ what is known as “AC coupling”. In such an implementation, the battery and renewable energy source(s) each have a transformer associated therewith, and the outputs of the transformers are coupled/combined together on the high voltage AC side of the system. In other implementations, the outputs of the battery and renewable energy source(s) are combined on the low-voltage side of a single transformer that is sized so that it is at least equal to the combined power of the sources. The transformer is sized in this manner in order to accommodate the condition wherein all of the energy sources would be exporting power at the same time (for example, a system wherein multiple small solar inverters are combined on a single transformer having a rating equal to the combined power of each of the solar inverters).

### SUMMARY

In one embodiment, a renewable energy system is provided that includes a transformer, the transformer having a power rating, a first inverter, the first inverter being coupled to a renewable energy source, wherein an output of the first inverter is provided to a primary side of the transformer, and wherein the first inverter has a first maximum output power rating, and a second inverter, the second inverter being coupled to an energy storage device, wherein an output of the second inverter is provided to the primary side of the transformer, and wherein the second converter has a second maximum output power rating. The system further includes a controller coupled to the first inverter and the second inverter, wherein the controller is structured and configured to control operation of the first inverter and the second inverter in a manner such that a total power provided to the primary side of the transformer does not exceed the power rating of the transformer, and wherein the power rating of the transformer is less than a sum of the first maximum output power rating, the second maximum output power rating, and each additional maximum output power rating of one or more additional inverters, if any, that are coupled to the transformer.

In another embodiment, a method of controlling a renewable energy system having a transformer having a power rating is provided. The method includes controlling a first inverter, the first inverter being coupled to a renewable energy source, wherein an output of the first inverter is provided to a primary side of the transformer, and wherein the first inverter has a first maximum output power rating, and controlling a second inverter, the second inverter being coupled to and energy storage device (12), wherein an output of the second inverter is provided to the primary side of the transformer, and wherein the second converter has a second maximum output power rating. In addition, in the method, as a result of the controlling of the first inverter and the controlling of the second inverter, the total power provided to the primary side of the transformer does not exceed the power rating of the transformer. Also, the power rating of the transformer is less than a sum of the first maximum output power rating, the second maximum output power rating, and each additional maximum output power rating of one or more additional inverters, if any, that are coupled to the transformer.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of a renewable energy system according to an exemplary embodiment of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the term “number” shall mean one or an integer greater than one (i.e., a plurality).

As employed herein, the statement that two or more parts are “coupled” together shall mean that the parts are joined together either directly or joined through one or more intermediate parts.

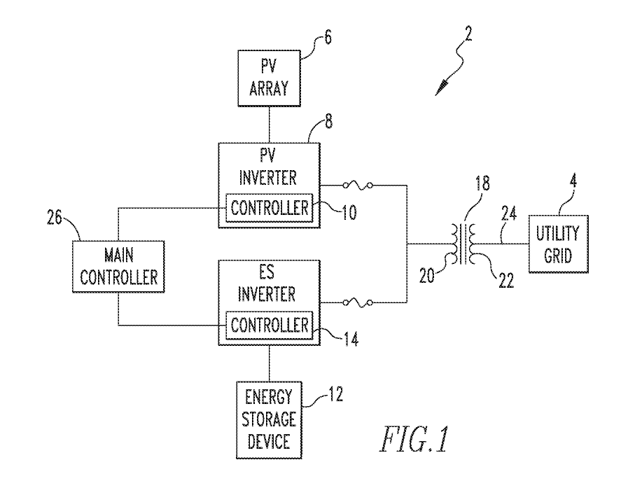

FIG. 1 is a schematic diagram of a renewable energy system 2 according to an exemplary embodiment of the disclosed concept. As seen in FIG. 1, renewable energy system 2 is interconnected with a utility grid 4 at a point of interconnection (POI) (also referred to as a point of common coupling (PCC)). Renewable energy system 2 includes a photovoltaic (PV) array 6 coupled to an associated photovoltaic (PV) inverter 8. PV inverter 8 has a controller 10 for controlling the operation thereof. While only a single PV array 6 and associated PV inverter 8 is shown for illustrative purposes, it will be understood that multiple PV arrays 6 and associated PV inverters 8 may be employed within the scope of the disclosed concept. As is known in the art, PV array 6 includes a plurality of solar panels structured to absorb and directly convert sunlight into DC electrical current, and PV inverter 8 is structured to convert the electrical current generated by the solar panels from DC to AC. PV inverters 8 has controls to limit the power output even when the available power from the associated PV array 6 is higher. Also, PV inverter 8 has the capability to absorb or supply reactive power.

As seen in FIG. 1, renewable energy system 2 further includes an energy storage device 12, such as, without limitation, a battery having a battery management system (BMS). Energy storage device 12 is coupled to an energy storage (ES) inverter 14 having a controller 16. Controller 16 controls the operation of ES inverter 14. Although only a single energy storage device 12 and a single ES inverter 14 are shown in the illustrated embodiment, it will be understood that a greater number of such components may also be used within the scope of the disclosed concept. Energy storage device 12 is structured to output DC current which is converted to an AC current by ES inverter 14. ES inverter 14 is also structured to be able to receive AC energy that is converted to DC energy that is subsequently stored by energy storage device 12.

Renewable energy system 2 further includes a transformer 18. As seen in FIG. 1, the output of PV inverter 8 is coupled to the primary (low-voltage) side 20 of transformer 18. Similarly, the output of ES inverter 14 is coupled to the primary side 20 of transformer 18. The secondary (high-voltage) side 22 of transformer 18 is coupled to a distribution line 24 which is coupled to utility grid 4. In the illustrated embodiment, transformer 18 steps up the inverter AC voltages to any suitable utility voltage (for example 13.2 kV).

Renewable energy system 2 also includes a main controller 26, such as, without limitation, a programmable logic controller (PLC) (or a similar processing device). As seen in FIG. 1, main controller 26 is coupled to controller 10 of PV inverter 8 and controller 16 of ES inverter 14 by any suitable connection scheme (wired or wireless), such as, without limitation, a local area network. As such, main controller 26 is able to issue control signals for selectively controlling the operation of PV inverter 8 and ES inverter 14 (by way of controller 10 and controller 16, respectively). In the exemplary embodiment, controller 26 comprises a processor portion and a memory portion. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory. The memory portion of controller 26 has stored therein a number of software routines, in the form of encoded computer program code, that are executable by the processor portion of controller 26 to enable operation and control of renewable energy system 2 as described herein.

In particular, according to an aspect of the disclosed concept, controller 26 is configured (by way of one or more stored routines as described above) to control PV inverter 8 and ES inverter 14 such that at no time the combined power output by PV inverter 8 and ES inverter 14 and provided to primary side 20 of transformer 18 is permitted to be greater than the power rating of transformer 18. This operational constraint, which takes advantage of the typically different usage cycles of PV inverter 8 and ES inverter 14, thus enables a smaller transformer 18 to be used as compared to the prior art, which, as described elsewhere herein, employs a single transformer that is sized so that it has a power rating that is at least equal to the combined power of all of the sources that are providing power thereto. In the non-limiting, exemplary embodiment, transformer 18 has a power rating that is less than the combined maximum power that may be output by PV inverter 8 and ES inverter 14 (each being a “maximum output power rating” of the respective inverter). For example, in one exemplary embodiment, PV inverter 8 and ES inverter 14 are each capable of producing a maximum of 2 MW of AC power (i.e., they each have maximum output power rating of 2 MW), and transformer 18 is sized to have a power rating of 2 MW. In such a configuration, controller 26 is configured to control PV inverter 8 and ES inverter 14 such that at no time will the combined power output by PV inverter 8 and ES inverter 14 and provided to primary side 20 of transformer 18 (for exportation to utility grid 4) be greater than 2 MW.

Thus, in operation, the 2 MW PV production of PV inverter 8 may be used entirely to provide AC energy to transformer 18 for exportation to utility grid 4, with ES inverter 14 not providing any power to transformer 18. Alternatively, the entirety of the 2 MW PV production of PV inverter 8 may be used to charge energy storage device 12. During such charging, no power will pass through transformer 18. As another alternative, part of the PV production of PV inverter 8 (e.g., 1 MW) may be provided to transformer 18 for exportation to utility grid 4, and part of the PV production of PV inverter 8 (e.g., 1 MW) may be provided to ES inverter 14 to charge energy storage device 12. In either case, if energy storage device 12 becomes full, then the PV power from PV inverter 8 may be provided to transformer 18 for exportation to utility grid 4. In still another alternative, less than the maximum output of PV inverter 8 (e.g., 1 MW) may be provided to transformer 18 (e.g., during a period of cloud cover), with supplementary power (e.g. 1 MW) being provided to transformer 18 by ES inverter 14 for exportation to utility grid 4 to smooth the PV production. In yet another alternative, PV production through PV inverter 8 may be shut down completely, with all energy (e.g., 2 MW) being provided to transformer 18 by ES inverter 8. In all situations, main controller 26 manages the power flow of PV inverter 8 and ES inverter 14 to maintain the power at a level that is within the rating of transformer 18, thus reducing and/or eliminating unused transformer capacity and therefore unnecessary cost.

As noted elsewhere herein, the disclosed concept is not limited to a single PV inverter and a single ES inverter being coupled to transformer 18 as shown in the exemplary embodiment of FIG. 1. Thus, in embodiments wherein inverters in addition to the PV inverter 8 and the ES inverter 14 are also coupled to the primary side 20 of transformer 18, transformer 18 will have a power rating that is less than the sum of the maximum output power ratings of all of the inverters coupled to transformer 18, and main controller 26 manages the power flow of the inverters to maintain the power at a level that is within the rating of transformer 18.

While the exemplary embodiments have been described herein in connection with renewables in the form of a number of PV arrays and PV inverters, it will be understood that that is meant to be exemplary only, and that other types of renewable energy sources, such as, without limitation, wind generation systems may also be used within the scope of the disclosed concept.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A renewable energy system, comprising:
a transformer, the transformer having a power rating;
a first inverter, the first inverter being coupled to a renewable energy source, wherein an output of the first inverter is provided to a primary side of the transformer, and wherein the first inverter has a first maximum output power rating;
a second inverter, the second inverter being coupled to an energy storage device, wherein an output of the second inverter is provided to the primary side of the transformer, and wherein the second converter has a second maximum output power rating;
a controller coupled to the first inverter and the second inverter, wherein the controller is structured and configured to control operation of the first inverter and the second inverter in a manner such that a total power provided to the primary side of the transformer does not exceed the power rating of the transformer, and wherein the power rating of the transformer is less than a sum of the first maximum output power rating, the second maximum output power rating, and each additional maximum output power rating of one or more additional inverters, if any, that are coupled to the transformer.

2. The renewable energy system according to claim 1, wherein no additional inverters are coupled to the transformer such that the power rating of the transformer is less than the sum of the first maximum output power rating and the second maximum output power rating, and wherein the total power provided to the primary side of the transformer as controlled by the controller is a sum of power output by the first inverter and power output by the second inverter.

3. The renewable energy system according to claim 1, wherein the first inverter is a photovoltaic inverter and wherein the renewable energy source is a photovoltaic array.

4. The renewable energy system according to claim 1, wherein the energy storage device comprises a battery.

5. A method of controlling a renewable energy system, the renewable energy system having a transformer having a power rating, the method comprising:
controlling a first inverter, the first inverter being coupled to a renewable energy source, wherein an output of the first inverter is provided to a primary side of the transformer, and wherein the first inverter has a first maximum output power rating;
controlling a second inverter, the second inverter being coupled to and energy storage device, wherein an output of the second inverter is provided to the primary side of the transformer, and wherein the second converter has a second maximum output power rating; and
wherein as a result of the controlling the first inverter and the controlling the second inverter, a total power provided to the primary side of the transformer does not exceed the power rating of the transformer, and wherein the power rating of the transformer is less than a sum of the first maximum output power rating, the second maximum output power rating, and each additional maximum output power rating of one or more additional inverters, if any, that are coupled to the transformer.

6. The method according to claim 5, wherein no additional inverters are coupled to the transformer such that the power rating of the transformer is less than the sum of the first maximum output power rating and the second maximum output power rating, and wherein the total power provided to the primary side of the transformer is a sum of power output by the first inverter and power output by the second inverter.

7. The method according to claim 5, wherein the first inverter is a photovoltaic inverter and wherein the renewable energy source is a photovoltaic array.

8. The method according to claim 5, wherein the energy storage device comprises a battery.

9. A computer program product including a non-transitory computer readable medium encoded with a computer program comprising program code for implementing the method of claim 5.

10. A controller for a renewable energy system including a processor portion and the computer program product of claim 9, wherein the computer program is executable by the processor portion.
